(19) United States
(12) Patent Application Publication
(10) Pub. No.: US 2019/0176217 A1
(43) Pub. Date: Jun. 13, 2019

(54) MANUFACTURING METHOD

(71) Applicant: Bridgestone Sports Co., Ltd., Tokyo (JP)

(72) Inventor: Tomonori KITAGAWA, Tokyo (JP)

(73) Assignee: Bridgestone Sports Co., Ltd., Tokyo (JP)

(21) Appl. No.: 16/178,718

(22) Filed: Nov. 2, 2018

(30) Foreign Application Priority Data
Dec. 13, 2017 (JP) 2017-238879

(51) Int. Cl. B21K 17/00; A63B 53/04; B23K 9/028; B24C 1/08

(52) U.S. Cl. CPC B21K 17/00; A63B 53/0466; A63B 2053/0437; B24C 1/08; A63B 2053/0445; B23K 9/028

(57) ABSTRACT

A method of manufacturing a wood-type golf club head, the golf club head including a face member that forms a face portion and a main body member to which the face member is to be joined, the method including a step of forming, in the face portion of the face member, a plurality of grooves and a concave portion extending so as to surround the plurality of grooves, a step of joining by welding the main body member and the face member in which the plurality of grooves and the concave portion are formed, and a step of grinding a region from the concave portion to an end portion of the main body member, the region including a welded portion between the face member and the main body member.

### BACKGROUND OF THE INVENTION

### Field of the Invention

The present invention relates to a wood-type golf club head.

### Description of the Related Art

There is proposed a method of improving the striking performance of a wood-type golf club head by the structure of a face portion. For example, a structure in which fine grooves are formed in the face portion is proposed in Japanese Patent Laid-Open Nos. 2016-16182 and 2016-16183. A structure in which a concave portion is formed around the face portion is proposed in Japanese Patent Laid-Open No. 2003-275343 and US-2015-0018119.

As a general surface processing technique, the use of an elastic abrasive as an abrasive (medium) for a blasting process has been proposed. An elastic abrasive obtained by dispersing abrasive grains on an elastic member such as rubber and elastomer and an elastic abrasive carrying abrasive grains on the surface of an elastic member are disclosed in Japanese Patent Nos. 2957492, 3376334, and 5250796.

Although cutting and laser processing can be used as a method to form fine grooves in the face portion, the golf club head needs to be positioned and fixed when these processes are to be performed. However, since the peripheral surface of the wood-type golf club head has a complex curved surface, it is not necessarily easy to fix the golf club head, and this may reduce productivity. Hence, the golf club head may be formed from a plurality of parts, grooves may be formed in a face member forming the face portion, and a main body member and the face member may be subsequently joined by welding. However, processes performed after the welding may have a negative influence on the grooves in some cases, and the formation of fine grooves may be difficult.

### SUMMARY OF THE INVENTION

It is an object of the present invention to provide a manufacturing method that can form finer grooves while improving productivity.

According to one aspect of the present invention, there is provided a method of manufacturing a wood-type golf club head, the golf club head including a face member that forms a face portion and a main body member to which the face member is to be joined, the method comprising: a step of forming, in the face portion of the face member, a plurality of grooves and a concave portion extending so as to surround the plurality of grooves; a step of joining by welding the main body member and the face member in which the plurality of grooves and the concave portion are formed; and a step of grinding a region from the concave portion to an end portion of the main body member, the region including a welded portion between the face member and the main body member.

Further features of the present invention will become apparent from the following description of exemplary embodiments (with reference to the attached drawings).

### BRIEF DESCRIPTION OF THE DRAWINGS

FIG. 1 is a front view of a golf club head according to an embodiment of the present invention;

FIGS. 2A and 2B are a left side view and a right side view, respectively, of the golf club head of FIG. 1;

FIG. 3 is an exploded perspective view of the golf club head of FIG. 1;

FIG. 4A is a sectional view taken along a line I-I of FIG. 1,

FIG. 4B is a partially enlarged view of FIG. 4A;

FIG. 5 is a flowchart showing an example of a manufacturing method of the golf club head of FIG. 1; and

FIGS. 6A to 6F are schematic views showing examples of sonic of the processes of the manufacturing method of FIG. 5.

### DESCRIPTION OF THE EMBODIMENTS

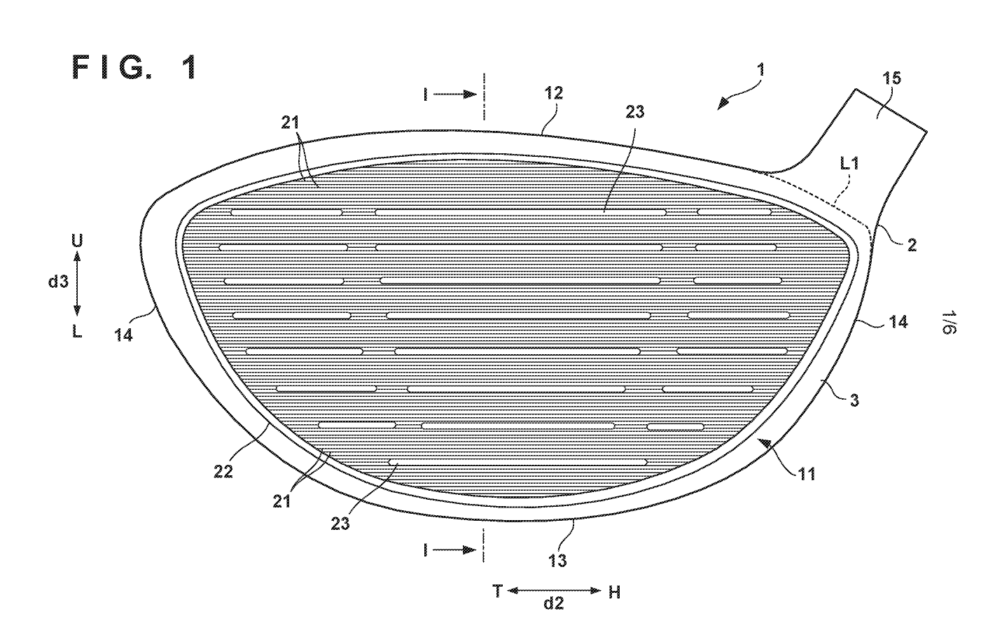

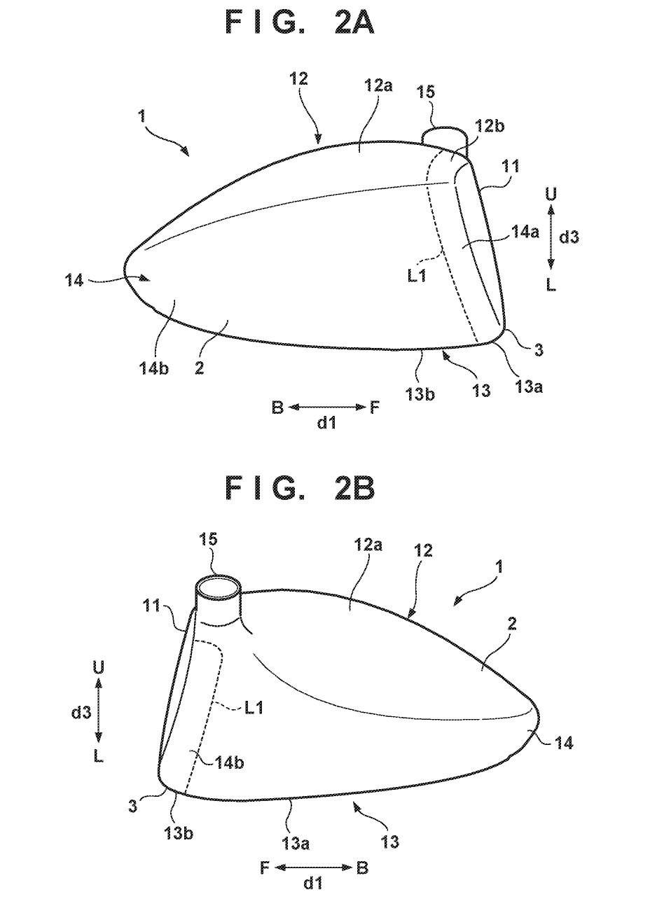

FIG. 1 is a front view of a golf club head 1 according to an embodiment of the present invention, and is a view in which the golf club head 1 is seen from the side of a face portion 11. FIG. 2A is a left side view and FIG. 2B is a right side view of the golf club head 1.

The golf club head 1 is a wood-type golf club head and forms a hollow member. The peripheral walls of the hollow member form the face portion 11, a crown portion 12, a sole portion 13, and a side portion 14. The surface of the face portion 11 forms a ball striking face. The crown portion 12 forms the upper portion of the golf club head 1. The sole portion 13 forms the bottom portion of the golf club head 1. The side portion 14 forms the portion between the sole portion 13 and the crown portion 12. The golf club head 1 also includes a hosel portion 15 to which a shaft is inserted.

In each drawing, an arrow d1 indicates a face-back direction, and reference symbols F and B indicate the side of the face portion and the back side, respectively. An arrow d2 indicates a toe-heel direction, and reference symbols T and H indicate the toe side and the heel side, respectively. An arrow d3 indicates a vertical direction (crown-sole direction), and reference symbols U and L indicate the upper side (crown side) and the lower side (sole side), respectively. The face-back direction is, for example, a target line direction (the target direction of a shot). The toe-heel direction is, for example, a direction in which the toe-side end and the heel-side end of the sole portion 13 are connected and has an orthogonal relationship to the target line direction. The vertical direction is the perpendicular direction obtained when the golf club head 1 is set on a horizontal plane in accordance with a predetermined lie angle and a predetermined loft angle, and the vertical direction has an orthogonal relationship to the directions indicated by the arrows d1 and d2.

The golf club head 1 is a golf club head for a driver. A bulge and a roll are formed on the face portion 11. The radius of curvature in the bulge direction of the face portion 11 is 200 mm (inclusive) to 400 mm (inclusive), and the radius of curvature in the roll direction is 200 mm (inclusive) to 400 mm (inclusive). Note that the present invention is applicable to wood-type golf club heads including those for fairway woods and the like, other than those of drivers. In particular, the present invention is suitable for a golf club head that has a loft angle degree equal to or smaller than 20°.

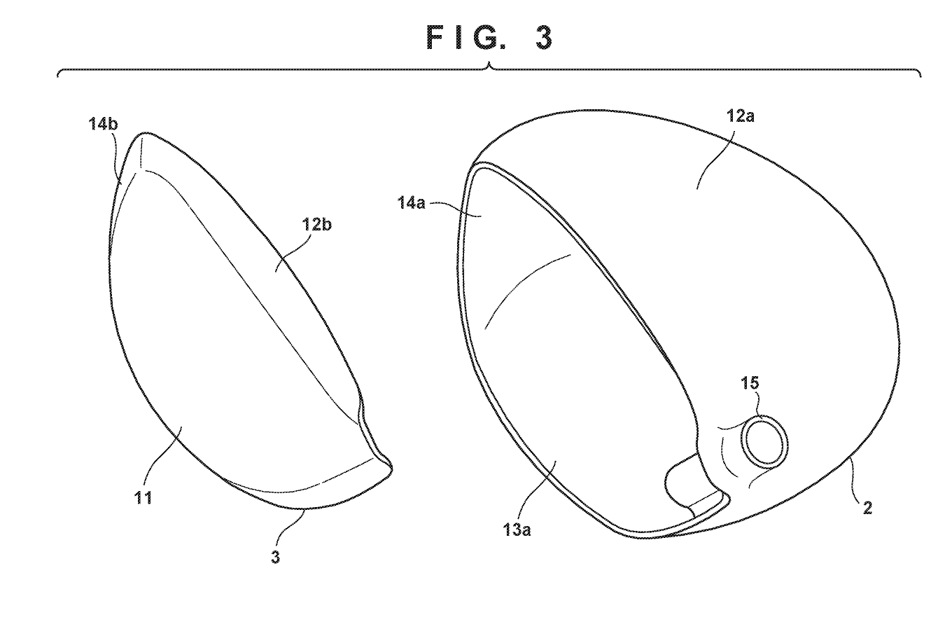

The golf club head 1 is assembled by joining a plurality of parts. FIG. 3 is an exploded perspective view of the golf club head 1. In this embodiment, the golf club head 1 is formed by two members, a main body member 2 and a face member 3. A broken line L1 shown in each drawing is the border line between the main body member 2 and the face member 3 and indicates a welding line where the both members are to be welded and joined.

The main body member 2 forms large parts (parts 12a, 13a, and 14a) of the crown portion 12, the sole portion 13, and the side portion 14 and the hosel portion 15, but does not form the face portion 11. Hence, the main body member 2 has a shape in which the front face is open. The face member 3 is joined to the main body member 2 so as to cover the front face of the main body member 2. In this embodiment, the face member 3 forms the overall face portion 11 and some parts (parts 12b, 13b, and 14b) of the crown portion 12, the sole portion 13, and the side portion 14. Hence, the face member 3 has a so-called cup shape. Note that the face member 3 may be a plate-like member that substantially forms only the face portion 11.

Although the golf club head 1 has been formed by two members, the golf club head 1 may be formed by three or more members. For example, it may have an arrangement in which, of the parts of the main body member 2, at least a portion of a part forming the crown portion 12 is set as the opening and is joined with a crown member which is a separate member. It may also have an arrangement in which at least a portion of a part forming the sole portion 13 is set as the opening and is joined to a sole member which is a separate member. Also, in this embodiment, although the hosel portion 15 is included in the main body member 2, it may be arranged so that the hosel portion 15 is included in the face member 3.

The golf club head 1 can be formed from a metal material, and examples of the metal material are a titanium-based metal (for example, titanium alloy 6Al-4V—Ti), stainless steel, an aluminum alloy, and a copper alloy such as betyllium copper.

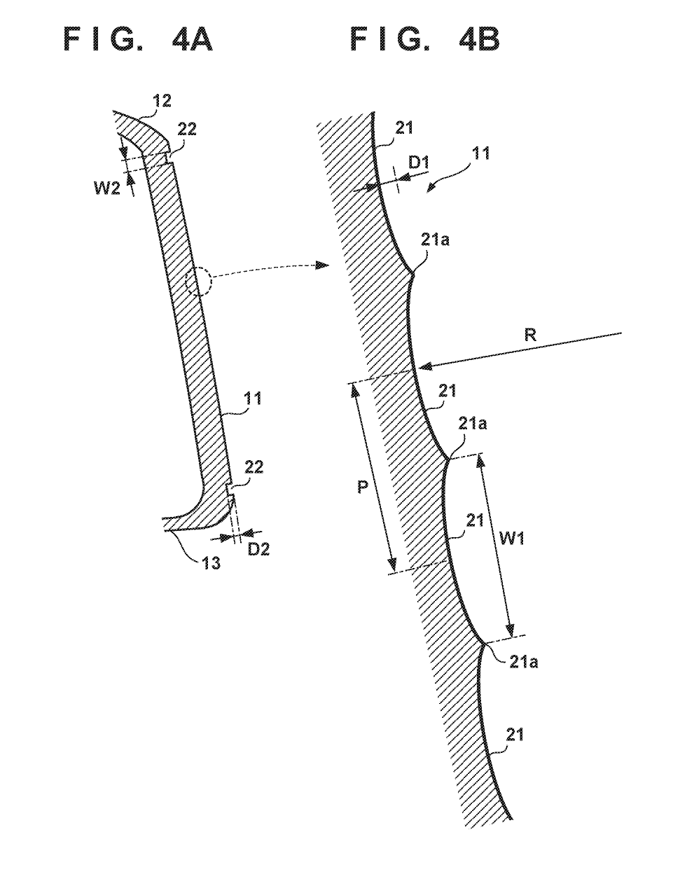

Referring to FIG. 1, a plurality of thin grooves 21, a concave portion 22, and patterns 23 are formed on the surface of the face portion 11. Note that illustrations of these components have been omitted in FIGS. 2A, 2B, and 3. FIG. 4A is a sectional view taken along a line I-I in FIG. 1, and is a longitudinal sectional view of the face portion 11. Since the thin grooves 21 are fine grooves, they are not illustrated in FIG. 4A, but are shown in FIG. 4B which is a partially enlarged view of the thin grooves.

In this embodiment, each thin groove 21 is a linear groove extending in the d2 direction. The plurality of thin grooves 21 are arrayed in the vertical direction (d3 direction) of the face portion 11 and are parallel to each other. Each thin groove 21 is formed so as to be level when the golf club head 1 is grounded toward the target direction. Although the thin grooves 21 are formed throughout the entire face portion 11 in this embodiment, they may be formed on a part of a region.

In this embodiment, each thin groove 21 is formed as a continuous straight line without a break. However, each thin groove may be formed with a break at a midway portion. The thin groove 21 may have a shape other than a line such as an arc shape, a triangular wave shape, or the like.

In this embodiment, each thin groove 21 is a shallow groove, and its depth D1 is, for example, 0.003 mm (inclusive) to 0.025 mm (exclusive). 0.015 mm is a representative value of the depth D1. A width W1 (a width in the d3 direction in the face direction of the face portion 11) of each thin groove 21 is, for example, 0.05 mm (inclusive) to 0.9 mm (inclusive). 0.5 mm is a representative value of the width W1. A pitch P between adjacent thin grooves 21 is, for example, 0.05 mm (inclusive) to 0.9 mm (inclusive). 0.5 mm is a representative value of the pitch P.

The depth D1, the width W1 of each thin groove 21, and the pitch P between adjacent thin grooves 21 may be equal to each other or may be different from each other. They are equal to each other in this embodiment. In this embodiment, the width W1 and the pitch P are equal to each other. Hence, each convex portion 21a which is positioned between adjacent thin grooves 21 has no substantial flat portion and has a cross-sectional outline shape with a high degree of sharpness.

The surface of the face portion 11 is roughened by the formation of the plurality of thin grooves 21 in this manner. In the case of a golf club head with a comparatively small loft angle (for example, 20° or smaller), an increase in the carry of a shot can be expected since the backspin amount decreases in accordance with an increase in the roughness of the surface of the face portion.

In this embodiment, as shown in FIG. 4B, the cross section of each thin groove 21 has an elliptic arc outline, and a radius of curvature R of the thin groove is, for example, less than 200 mm. Also, the sharpness of each convex portion 21a can be increased by setting the radius of curvature R to be smaller than the radius of curvature of the roll of the face portion 11. However, the outline shape of the cross section of each thin groove 21 is not limited to this, and various outline shapes such as an arc shape, triangular shape, rectangular shape, and trapezoidal shape can be employed.

The concave portion 22 is provided to protect the thin grooves 21 in the manufacturing process (to be described later) of the golf club head 1. The concave portion 22 is formed to surround the plurality of thin grooves 21. More specifically, the concave portion 22 extends around the plurality of thin grooves 21 so as to delimit the formation region of the plurality of thing grooves. Particularly in embodiment, the concave portion 22 is formed in an endless belt shape (annular shape). However, the concave portion may break midway. In this embodiment, the ends of each thin groove 21 communicate with the concave portion 22. However, the ends of the thin grooves and the concave portion may be spaced apart from each other.

A depth D2 of the concave portion 22 is, for example, 0.1 mm (inclusive) to 2.0 mm (inclusive). A width W2 (a width in a direction perpendicular to the direction in which the concave portion 22 extends) is, for example, 1.0 mm (inclusive) to 5.0 mm (inclusive).

The patterns 23 are formed for improving the design of the golf club head 1, adjusting the roughness of the surface of the face portion 11, or for the golfer to confirm the target direction and the direction of the face portion 11 at address. In this embodiment, each pattern 23 is a straight line extending in the d2 direction and is formed as a mark like a score line.

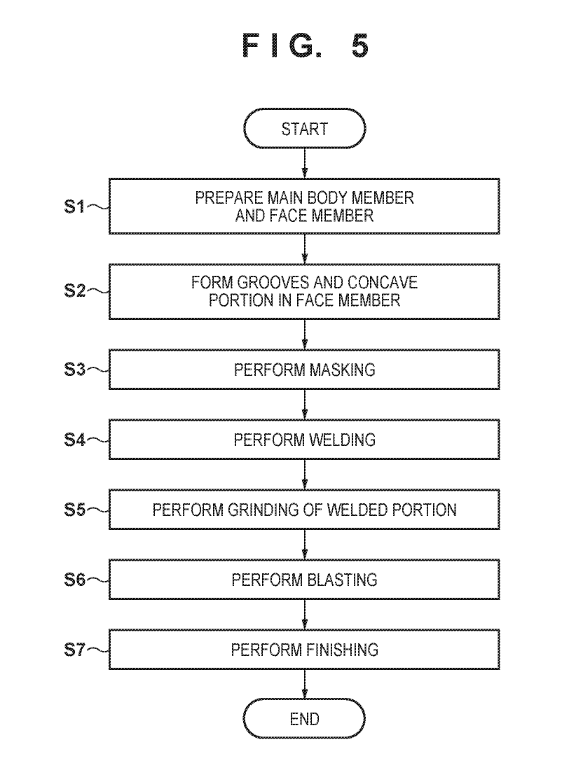

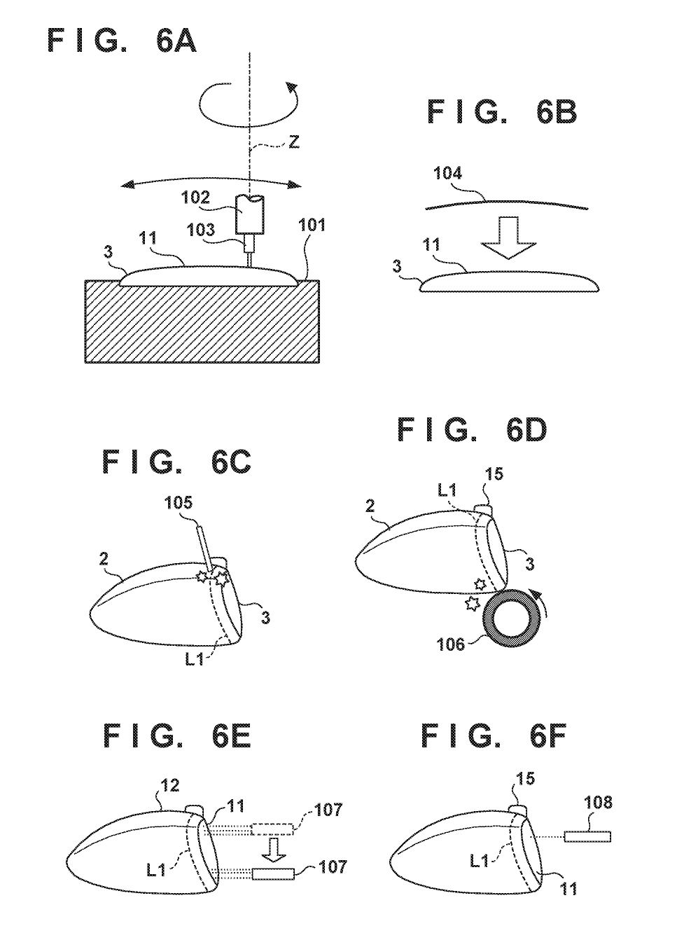

An example of the method of manufacturing the golf club head 1 will be described next. FIG. 5 is a flowchart showing an example of the manufacturing method, and FIGS. 6A to 6F are schematic views showing examples of some of the processes.

In step S1, the main body member 2 and the face member 3 are prepared. These members can be formed by, for example, casting, forging., press molding, a 3D printer, and other molding methods. At this stage, the plurality of thin grooves 21, the concave portion 22, and the patterns 23 have not been formed on the face portion 11 of the face member 3. The bulge and the roll have been formed on the face portion of the face member.

In step S2, the plurality of thin grooves 21 and the concave portion 22 are formed in the face portion 11 of the face member 3. Either the thin grooves 21 or the concave portion 22 may be formed first. These parts may be formed by machining or laser processing. FIG. 6A shows an example of the formation of the plurality of thin grooves 21 by machining. FIG. 6A shows an example in which the thin grooves 21 are formed by cutting by an NC milling machine. The face member 3 is fixed to the NC milling machine via a jig 101. The NC milling machine includes a spindle 102 that is rotatably driven about the Z-axis, and a cutting tool (end mill) 103 is attached to the lower end of the spindle 102. Since the face portion 11 has a bulge and a roll, each thin groove 21 is formed by three-dimensionally moving the cutting tool 103 by numerical control. The concave portion 22 may be formed next after the formation of the thin grooves 21.

The width W1 and the pitch P of the thin grooves 21 of the golf club head 1 according to this embodiment are equal to each other, and high machining precision is required to make such thin grooves 21. Furthermore, since the face portion 11 has a bulge and a roll, even higher machining precision is required. Hence, the face portion 11 needs to be fixed tightly. In this embodiment, the thin grooves 21 are formed before the main body member 2 and the face member 3 are joined, and the forming process is performed by fixing only the face member 3 to the NC milling machine. The peripheral surface of the golf club head 1 has a complex curved surface, and it is not easy to fix the face member 3 to the NC milling machine if the thin grooves 21 are to be formed after the face member 3 is joined to the main body member 2. Fixing is comparatively easy when only the face member 3 is to be fixed to the machine. Particularly, if most of the joint surface (portion to be joined to the main body member 2) of the face member 3 is on the same plane, it becomes easier to fix the face member. In this embodiment, of the face member 3, a portion other than a portion which is to be joined to the periphery of the hosel portion 15 is positioned on the same plane, thereby allowing the face member to be fixed more easily.

When the formation of the plurality of thin grooves 21 and the concave portion 22 is completed, masking of the face portion 11 is performed in step S3. Here, as shown in FIG. 6B, a protective sheet 104 is pasted onto the face portion 11 to protect the thin grooves 21. The protective sheet 104 is a paper or resin film. This prevents damage to the thin grooves 21 in the subsequent manufacturing processes.

Next, in step S4, the main body member 2 and the face member 3 are joined by welding. As shown in FIG. 6C, the main body member 2 and the face member 3, which have been temporarily fixed, are welded along the welding line L1 by a welding device 105. For example, the welding operation is performed manually by a worker.

When the joining of the main body member 2 and the face member 3 is completed, the welded portion is grinded in step S5, and the uneven welded portion is made smooth. For example, as shown in FIG. 6D, a worker can manually grind the welded portion by a grinding device such as a grinder 106 or the like. If the portions where the thin grooves 21 are formed are grinded during the grinding operation, the convex portions 21a will become worn down. In this embodiment, the formation of the concave portion 22 can prevent the worker from grinding the portions where the thin grooves 21 are formed. That is, the concave portion 22 can serve as a mark for the worker, and the worker can easily grind the region, including the welded portion, from the concave portion 22 to an end portion of the main body member 2. The interior wall of the concave portion 22 also functions as a wall that stops the grinder 106 from entering the portions where the thin grooves 21 are formed. Hence, this can prevent the worker from erroneously cutting the convex portion 21a.

An oxide film is at least partially formed on the face portion 11 by the welding operation of step S4. In particular, since this embodiment has a structure in which the welding line L1 passes between the face portion 11 and the hosel portion 15 (see FIG. 1), and an oxide film can easily be formed on the face portion 11 at least in this periphery. An oxide film can cause discoloration and reduction in durability, and the removal of this oxide film is highly necessary. Therefore, upon completion of the grinding of the welded portion, blasting of the face portion 11 is performed in step S6. Here, as shown in FIG. 6E, an abrasive is blasted onto the face portion 11 from a nozzle 107 to polish the face portion 11. Parts other than the face portion 11 may also be polished.

An elastic abrasive is used as the abrasive. An elastic abrasive is a material obtained by dispersing abrasive grains on an elastic member such as rubber or elastomer or an elastic member carrying abrasive grains on its surface. “Sirius Z Media” (tradename) available from Fuji Manufacturing Co., Ltd. is an example of a suitable elastic abrasive. Using the elastic abrasive can prevent the formation of a matte uneven surface of a workpiece by the blasting. That is, it can prevent abrasion and flattening of the convex portions 21a while removing the oxide film. In addition, the use of the elastic abrasive can improve the design of the golf club head 1 by increasing the degree of the mirror finish of the face portion 11.

When blasting has been completed, the finishing process in step S7 is performed. Here, the formation of the patterns 23, the coating of the golf club head 1, and the like are performed. In the formation of the patterns 23, the patterns 23 may be formed by irradiating the surface of the face portion 11 with a laser beam by a laser processing machine 108 as shown in FIG. 6F.

The golf club head 1 is completed by the above-described processes. In this embodiment, the machining precision can be increased by forming the thin grooves 21 before the face member 3 is joined to the main body member 2, the grinding of the portions where the thin grooves 21 are formed can be prevented in the grinding process (step S5) by the formation of the concave portion 22, and furthermore, the abrasion of the convex portions 21a can be suppressed while removing the oxide film by using an elastic abrasive as a medium in the blasting process (step SC). As a result, in this embodiment, it is possible to provide the wood-type golf club head I in which the finer thin grooves 21 are formed while also improving the productivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2017-238879, filed Dec. 13, 2017, which is hereby incorporated by reference herein in its entirety.

What is claimed is:

1. A method of manufacturing a wood-type golf club head, the golf club head including a face member that forms a face portion and a main body member to which the face member is to be joined,
the method comprising:
a step of forming, in the face portion of the face member, a plurality of grooves and a concave portion extending so as to surround the plurality of grooves;
a step of joining by welding the main body member and the face member in which the plurality of grooves and the concave portion are formed; and
a step of grinding a region from the concave portion to an end portion of the main body member, the region including a welded portion between the face member and the main body member.

2. The method according to claim 1, wherein the concave portion is an endless concave portion extending so as to surround the plurality of grooves.

3. The method according to claim 1, further comprising a step of blasting an elastic abrasive to the face portion after the step of joining.

4. The method according to claim 3, wherein the main body member includes a hosel portion to which a shaft is to be inserted, and
a welding line in the step of joining passes between the face portion and the hosel portion.

5. The method according to claim 3, wherein in the step of blasting, an oxide film formed on the face portion in the step of joining is removed.
